(19) United States
(12) Patent Application Publication
(10) Pub. No.: US 2026/0253925 A1
(43) Pub. Date: Aug. 27, 2026

(54) FUEL-CELL SYSTEM SHUTDOWN

(71) Applicant: FORD GLOBAL TECHNOLOGIES, LLC, Dearborn, MI (US)

(72) Inventors: Hao WANG, Ann Arbor, MI (US); Matthew RILEY, Ann Arbor, MI (US); William Frederick SANDERSON, JR., Commerce Township, MI (US); Kevin Ray RUYBAL, Canton, MI (US); Michael J. VAN NIEUWSTADT, Ann Arbor, MI (US)

(21) Appl. No.: 19/061,524

(22) Filed: Feb. 24, 2025

(51) Int. Cl. H01M 8/04223; B60L 58/30; H01M 8/04228; H01M 8/04303; H01M 8/0438; H01M 8/0444; H01M 8/04746; H01M 8/04828

(52) U.S. Cl. CPC H01M 8/04231; B60L 58/30; H01M 8/04228; H01M 8/04303; H01M 8/04388; H01M 8/04395; H01M 8/04462; H01M 8/04753; H01M 8/04761; H01M 8/04776; H01M 8/04783; H01M 8/04828; H01M 2250/20

(57) ABSTRACT

A fuel-cell stack, an air-supply system including a compressor in fluid communication with a cathode inlet of the fuel-cell stack, an exhaust in fluid communication with anode and cathode outlets of the fuel-cell stack, and a purge valve in fluid communication with the anode outlet of the fuel-cell stack. A processor is programmed to, during a shutdown of the fuel-cell stack when the compressor has power: keep the purge valve open until a hydrogen concentration in the exhaust exceeds a threshold, and reduce a speed of the compressor such that a pressure difference between anode and cathode sides of the fuel-cell stack is reduced.

### STATEMENT REGARDING FEDERALLY SPONSORED RESEARCH OR DEVELOPMENT

This invention was made with Government support under Contract No. DE-EE0009858 awarded by the Office of Energy Efficiency and Renewable Energy, The Government has certain rights in the invention.

### TECHNICAL FIELD

This disclosure relates to vehicle fuel cells and more specifically to controls for shutting down the fuel cell.

### BACKGROUND

The hydrogen fuel cell, and in particular the proton exchange membrane fuel cell (PEMFC), is one potential power source for automobiles and stationary applications. The reaction in a PEMFC involves hydrogen molecules splitting into protons and electrons at the anode, while protons re-combine with oxygen and electrons to form water and release heat at the cathode. Typically, a proton exchange membrane is used as a proton conductor in a PEMFC. A catalyst layer containing, for example, platinum and/or a platinum alloy is used to catalyze the electrode reactions. A gas diffusion layer, which may include a microporous layer and a gas diffusion backing layer, is used to transport reactant gases and electrons as well as remove product water and heat.

### SUMMARY

According to one embodiment, a fuel-cell stack, an air-supply system including a compressor in fluid communication with a cathode inlet of the fuel-cell stack, an exhaust in fluid communication with anode and cathode outlets of the fuel-cell stack, and a purge valve in fluid communication with the anode outlet of the fuel-cell stack. A processor is programmed to, during a shutdown of the fuel-cell stack when the compressor has power: keep the purge valve open until a hydrogen concentration in the exhaust exceeds a threshold, and adjust the speed of the compressor such that a pressure difference between anode and cathode sides of the fuel-cell stack is maintained within acceptable limits for hardware protection of the membrane. The position of the cathode valve may also be adjusted to manage cross pressures,

According to another embodiment, a fuel-cell system includes a processor programmed to, during shutdown of a fuel-cell stack while a compressor of the fuel-cell system is deactivated, open a purge valve in fluid communication of au anode outlet of the fuel-cell stack, adjust a position of a cathode exhaust valve based on a pressure difference between an anode side of the fuel-cell stack and a cathode side of the fuel-cell stack.

According to yet another embodiment, a method of shutting down a fuel-cell stack includes discontinuing flow of hydrogen to the fuel-cell stack, opening a purge valve in fluid communication with an anode outlet of the fuel-cell stack for as long as a concentration of hydrogen in an exhaust of the fuel-cell stack remains less than a threshold; and adjusting a position of a cathode exhaust valve to maintain a pressure difference between an anode and a cathode of the fuel-cell stack less than a threshold.

### BRIEF DESCRIPTION OF THE DRAWINGS

FIG. 1 is a schematic of a fuel cell vehicle.

FIG. 2 is an exploded view of a proton exchange membrane fuel-cell stack.

FIG. 3 is a schematic diagram of a fuel-cell system.

FIG. 4 is a flow chart of an algorithm for shutting down a fuel cell.

FIG. 5 is a plot showing valve positions and pressures during a hypothetical shutdown of the fuel-cell stack.

### DETAILED DESCRIPTION

Embodiments of the present disclosure are described herein. It is to be understood. however, that the disclosed embodiments are merely examples and other embodiments can take various and alternative forms. The figures are not necessarily to scale; some features could be aggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure. however, could be desired for particular applications or implementations.

PEMFC is a popular fuel cell choice for automotive vehicles. The PEMFC generally includes a proton exchange membrane (PEM). The anode and the cathode typically include finely divided catalytic particles, usually platinum, supported on carbon particles and mixed with an ionomer. The catalytic mixture is deposited on opposing sides of the membrane. The combination of the anode-catalytic mixture, the cathode-catalytic mixture, and the PEM form a coated catalyst membrane electrode (CCM). In order to facilitate the transport of reactant gases to and remove the excessive water and heat from the catalytic mixture, a gas diffusion layer (GDL), which may include a microporous layer and a carbon-fiber-based gas diffusion backing layer, may be applied on either side of the CCM to form a membrane electrode assembly (MEA). GDLs also provide mechanical support for the soft goods including the PEM and catalytic mixtures.

MEAs are sandwiched between bipolar plates to form unit cells. The bipolar plates typically include an anode side and a cathode side. Anode fuel flow channels are provided on the anode side of the bipolar plates that allow the anode gas to flow to the anode side of the MEA. Cathode oxidant flow channels are provided on the cathode side of the bipolar plates that allow the cathode gas to flow to the cathode side of the MEA. Coolant channels may be disposed between the anode and cathode sides of the bipolar plates to heat and/or cool the fuel cell.

Several unit cells are typically combined in a fuel-cell stack to generate the desired power. For example, the stack may include two hundred or more unit cells arranged in series. The fuel-cell stack receives a cathode reacting gas, typically a flow of air forced through the stack by a compressor. Not all the oxygen is consumed by the stack and some of the air is output as a cathode exhaust gas that may include water as a stack byproduct. The fuel-cell stack also receives an anode hydrogen reacting gas that flows into the anode side of the stack.

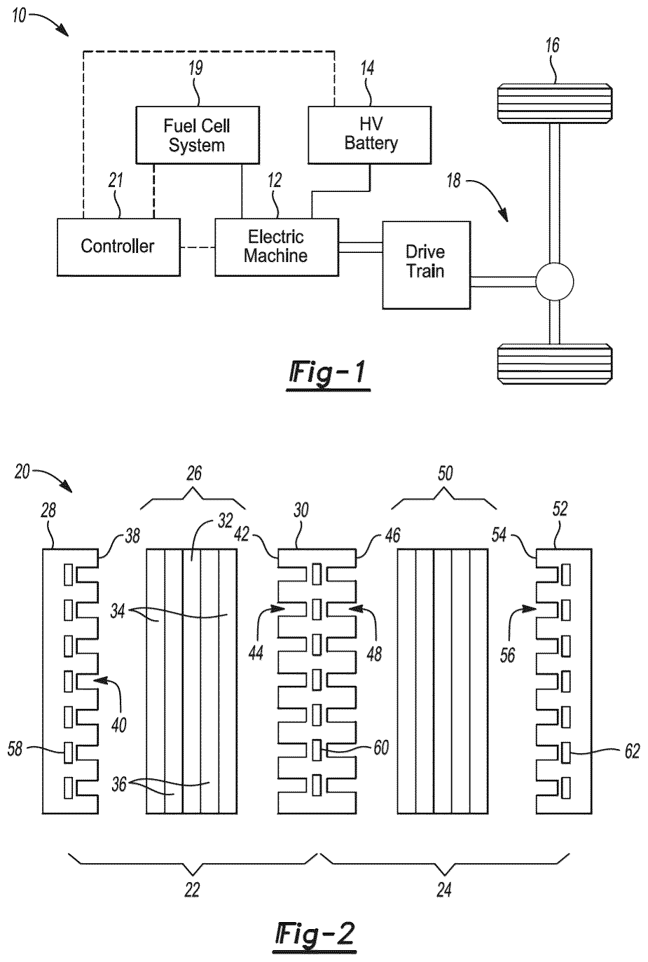

Referring to FIG. 1, a vehicle 10 includes a fuel-cell system 19 for providing electrical power to at least one electric machine 12. The vehicle 10 may also include a traction battery 14 electrically connected to the fuel-cell system 19 and the electric machine 12. The electric machine 12 is connected to the driven wheels 16 via a drivetrain 18. During operation of the vehicle 10, hydrogen fuel and air are fed into a fuel cell of the system 19 creating electrical power. The electric machine 12 receives the electrical power as an input, and outputs torque for driving the wheels 16 to propel the vehicle 10.

The vehicle 10 also includes at least one controller 21 that controls one or more systems of the vehicle, such as those systems shown in FIG. 1. While illustrated as one controller, the controller 21 may be part of a larger control system and may be controlled by various other controllers throughout the vehicle 10, such as a vehicle system controller (VSC), It should therefore be understood that the controller 21 and one or more other controllers can collectively be referred to as a “controller” that controls various actuators in response to signals from various sensors to control functions such as controlling the fuel-cell system. Controller 21 includes a processor programmed to execute instructions, such as fuel cell shutdown, and associated memory. For example, controller 21 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the vehicle.

The controller communicates with various vehicle sensors and actuators via an input/output (I/O) interface that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. Although not explicitly illustrated, those of ordinary skill in the art will recognize various functions or components that may be controlled by controller 21 within each of the subsystems identified above. Representative examples of parameters, systems, and/or components that may be directly or indirectly actuated using control logic executed by the controller.

Referring to FIG. 2, an example fuel cell 20 of the system 19 includes two unit cells 22. 24 stacked together. The two-cell stack is merely an example and the fuel cell 20 may include dozens or hundreds of stacked unit cells. The first unit cell 22 includes an MEA 26 sandwiched between a first end plate 28 and a bipolar plate 30. The MEA 26 is comprised of a plurality of different layers including a PEM 32, a pair of gas diffusion layers (GDL) 34 and a pair of catalyst layers 36. The endplate 28 includes an anode side 38 defining a plurality of flow paths 40 for the hydrogen fuel. The bipolar plate 30 includes a cathode side 42 defining a plurality of flow paths 44 for air and an anode side 46 defining a plurality of flow paths 48 for hydrogen fuel for the second unit cell 24. A second MEA 50 is sandwiched between the bipolar plate 30 and a last endplate 52. The last endplate 52 includes a cathode side 54 defining a plurality of flow paths 56 for air. The coolant channels 58, 60, 62 are configured to circulate coolant, such as ethylene glycol.

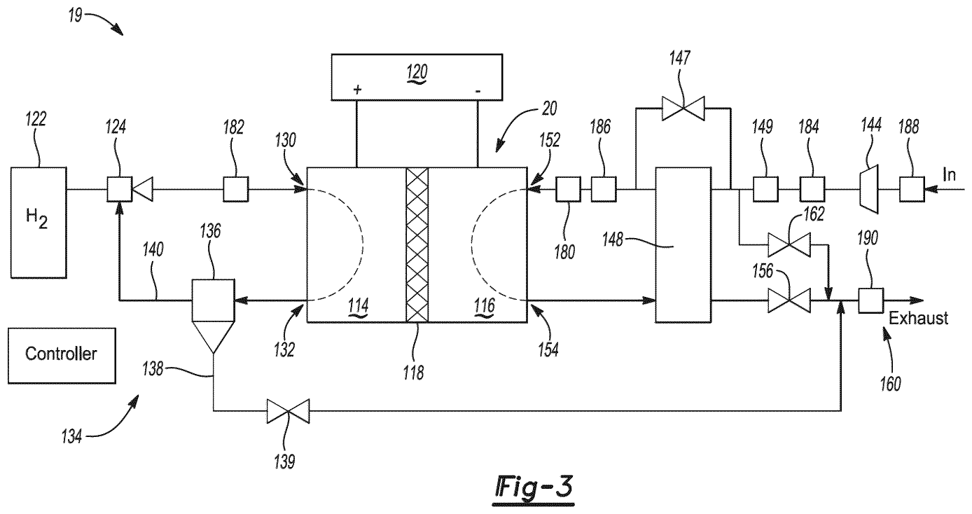

Referring to FIG. 3, the fuel-cell system 19 includes the fuel-cell stack 20. The stack 20 contains an anode side 114, a cathode side 116, and a membrane 118 therebetween. The fuel-cell stack 20 provides electrical energy, for example, to a high-voltage bus 120 or a traction battery. The fuel-cell stack 20 may also have a cooling loop (not shown)

During operation of the fuel-cell system 19, product water, residual fuel such as hydrogen, and byproducts such as nitrogen, may accumulate at the anode side 114 of the fuel-cell stack 20. One example approach is to collect those constituents in a separator 136 downstream of the fuel-cell stack 20, separate at least a portion of the liquid water, and return the remaining constituents to the fuel-cell stack 20 via a return passageway in a recirculation loop.

A primary fuel source 122 is connected to the anode side 114 of the fuel-cell stack 20, such as a primary hydrogen source. Non-limiting examples of the primary hydrogen source 122 are a high-pressure hydrogen storage tank or a hydride storage device. The hydrogen source 122 is connected to one or more ejectors 124 that control the flow of hydrogen to the stack. The ejector 124 may be or include a valve configured to control the flow of hydrogen. The ejector 124 has a nozzle supplying hydrogen into the converging section of a converging-diverging nozzle. The diverging section of the nozzle is connected to the input 130 of the anode side 114. This may be collectively referred to as a hydrogen supply.

The output 132 of the anode side 114 may be connected to a passive recirculation loop 134. An excess of hydrogen gas may be provided to the anode side 114 to ensure that there is sufficient hydrogen available to all of the cells in the stack 20. In other words, hydrogen is provided to the fuel-cell stack 20 above a stoichiometric ratio of one, i.e., at a fuel-rich ratio relative to exact electrochemical needs. The recirculation loop 134 is provided so that excess hydrogen unused by the anode side 114 is returned to the input 130 via the ejector 124 so it may be used and not wasted.

Additionally, accumulated liquid and vapor phase water is an output of the anode side 114. The anode side 114 requires humidification for efficient chemical conversion and to extend membrane life. The recirculation loop 134 may be used to provide water to humidify the hydrogen gas before the input 130 of the anode side 114.

The recirculation loop 134 includes the hydrogen-water separator 136, or water knock-out device. The separator 136 receives a stream or fluid mixture of hydrogen gas, nitrogen gas, and water from the output 132 of the anode side 114. The water may be mixed phase and contain both liquid and vapor. The separator 136 removes at least a portion of the liquid-phase water, which exits the separator through a drain line 138. At least a portion of the nitrogen gas, hydrogen gas, and vapor-phase water may also exit the drain line 138, and pass through a purge valve 139, for example, during a purge process of the fuel-cell stack 20. The remainder of the fluid in the separator 136 exits through passageway 140 in the recirculation loop 134, which is connected to the ejector 124. The fluid in passageway 140 is fed into the converging section of the converging-diverging nozzle where it mixes with incoming hydrogen from the hydrogen source 122.

Liquid water may be removed from the anode side 114 by the separator 136 to prevent water blockages within the channels and cells of the anode side 114. Water blockages within the fuel-cell stack 20 may decrease cell voltage and/or voltage instabilities within the fuel-cell stack 20. Liquid water may also be removed by the separator 136 to prevent a blockage or partial blockage within the ejector 124. A liquid water droplet in the diverging section of the converging-diverging nozzle could effectively create a second venturi section within the nozzle and lead to pumping instabilities for the ejector 124.

The cathode side 116 of the stack 20 receives oxygen, for example, as a constituent in an air source 142 (i.e., ambient air). The oxygen is supplied by an oxygen (or air) supply system. In one embodiment, a compressor 144 is driven by a motor to pressurize the incoming air. The pressurized air is then humidified by a humidifier 148 before entering the cathode side 116 at the input 152. An optional intercooler 149 may be used to cool the compressed air exiting the compressor 144. Another separator (not shown) may be positioned downstream of the humidifier 148. The separator may be used to remove liquid water from the humidified air flow before it enters the cathode input 152. Water droplets may be present downstream of the humidifier 148 due to liquid water being entrained by high flow rates within the humidifier 148. Liquid water may be removed by the separator to prevent water blockages within the cells of the cathode side 116, leading to decreases in cell voltage and/or instabilities within the fuel-cell stack 20. The output 154 of the cathode side 116 is connected to a valve 156. Drain line 138 from separator 136 and the output of the valve 156 may be connected to an exhaust 160 downstream of the valve 156. In other embodiments, the drain lines may be plumbed to other locations in the fuel-cell system 19.

A humidifier bypass valve 147 is used to bypass some air around the humidifier 148. When the valve 147 is closed, all the compressed an is routed through the humidifier 148. The valve 147 may be partially of fully opened to bleed a portion of the pressurized air directly to the input 152. A system bypass valve 162 is used to bypass the cathode side 116 of the fuel-cell stack 20 and route compressed air directly to the exhaust 160. When the valve 162 is closed, all the compressed air is routed into the input 152 of the fuel-cell stack 20. The valve 162 may be partially of fully opened to bleed a portion of the pressurized air directly to the exhaust 160.

The fuel-cell system 19 includes a plurality of associated sensors. Each of the sensors is configured to output data/signals indicative of its measured value. The sensors are an electric communication with the controller 21, which is programmed to receive the data and interpret the data as the measured value. Example sensors include a cathode pressure sensor 180, an anode pressure sensor 182, a mass air flow sensor 184, a humidity sensor 186, an ambient air temperature sensor 188, a hydrogen concentration sensor 190, and the like. The sensor placements are exemplary and may be in different locations in other embodiments. For example, the pressure sensors 180 and 182 may be placed near the outlets rather than the inlets as shown in FIG. 3.

FIG. 3 illustrates a plurality of lines that graphically represent the air flow paths of the fuel and air systems. These flow paths may be formed within conduits, hoses, tubes, pipes, plenums, manifolds, or any other structure capable of defining an airway.

FIG. 3 is just one example, and other system architectures may also be used for the fuel-cell system 19.

Shutting down a fuel-cell is not as simple as cutting the fuel and air to the fuel-cell stack. Instead, a shutdown procedure is required to gently hold the chemical reactions occurring therein to ensure longevity of the internal components.

There are times when a rapid shutdown of the fuel cell is desired. Described below are controls and methods for rapidly shutting down a fuel cell without stressing the internal components thus maintaining longevity of the fuel-cell stack. The below described controls are capable of quickly shutting down the fuel-cell stack while limiting a concentration of hydrogen within the exhaust below a target, maintaining desired cross pressure between the anode and cathode sides, and preventing excessive accumulation of residual water within the stack.

Control logic or functions performed by controller 21 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein but is provided for ease of illustration and description. The control logic may be implemented primarily in software executed by a microprocessor-based vehicle, engine, and/or powertrain controller, such as controller 21. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

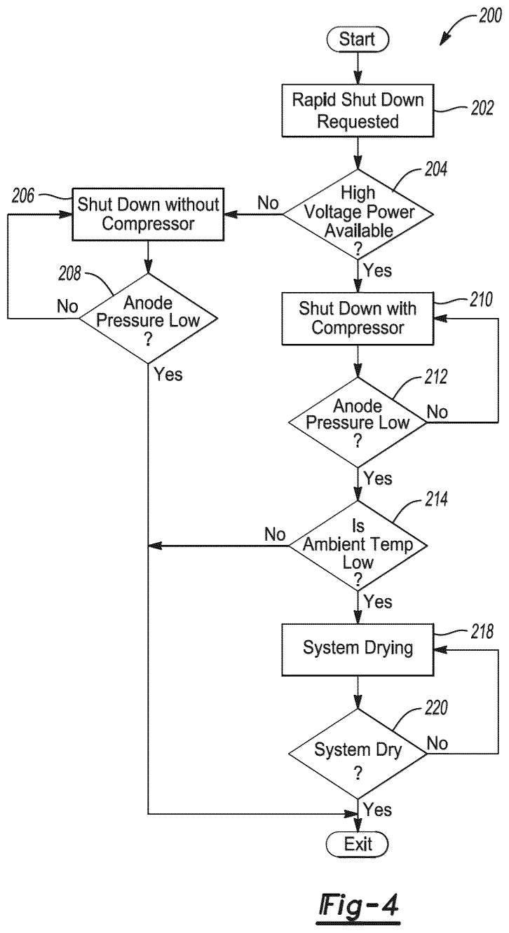

FIG. 4 illustrates control logic 200 for executing a rapid shutdown of the fuel-cell stack. Control begins at operation 202 when a rapid shutdown of the fuel cell is requested. At operation 204, the controller determines if high-voltage power is available (or alternatively, determine if the compressor has power). The compressor of the fuel-cell system may operate on the high-voltage bus; in that case, the availability of high-voltage power determines whether or not the compressor can be used during the rapid shutdown or not. If high-voltage power is not available control passes to operation 206.

At operation 206, the controller executes a rapid shutdown of the fuel-cell without using the compressor. Some objectives during rapid shutdown are to maintain fuel-cell stack cross pressure within desired limits, maintain hydrogen concentration within the exhaust system below a threshold, and to remove anode gas from the fuel-cell stack as needed to control cross pressures. Fuel-cell stack cross pressure refers to the pressure differential between the anode side and the cathode side of the fuel-cell stack. The pressures within the anode and cathode can be determined based on the pressure sensors, e.g., 180, 182 either alone or in combination with the flow rates of the gases and/or other sensed conditions.

It is challenging to maintain the cross pressures when the compressor lacks power because neither the cathode inlet nor the anode inlet is receiving flow. Therefore, the tools available for managing cross pressure are the hydrogen exhaust purge valve, e.g., valve 139, the cathode exhaust valve, e.g. valve 156, and the system bypass valve, e.g., valve 162. During operation 206, the processor of the controller is programmed to actuate one or more of these valves to maintain desired cross pressures, which may include evacuating hydrogen fuel from the fuel-cell stack if the cross pressure is too high and hydrogen concentration within the exhaust is less than a threshold.

In one or more embodiments, the controller discontinues hydrogen supply via a valve and discontinues current draw in response to the rapid shutdown. The controller may also open the purge valve to evacuate hydrogen from the anode based on cross pressures, Opening the purge valve results in the release of hydrogen fuel into the exhaust. Since the compressor is powerless, the lack of air through the cathode can result in an increase in the concentration of hydrogen within the exhaust. The controller manages the concentration of hydrogen in the exhaust by comparing a measured value of the hydrogen concentration to a threshold. The purge valve may remain open until the hydrogen concentration exceeds threshold, at which point, the controller closes the purge valve at least until the hydrogen concentration drops below threshold.

The lack of compressor power results in a pressure drop in the cathode. Opening the purge valve lowers pressure within the anode and can be used to reduce anode pressure. Therefore, during the shutdown, the controller modulates the position of the exhaust valve 156 based on a pressure difference between an anode side of the fuel-cell stack and a cathode side of the fuel-cell stack to maintain the cross pressures within a desired operating envelope. The cathode exhaust valve may be a multi-position valve that is controlled using closed-loop feedback controls such as P, PI, or PID controls. In one example, the controller sets a target pressure for the cathode (which is based on the pressure of the anode) and controls the exhaust valve to reduce an error between the cathode pressure and the target. During the shutdown, the controller may also open the bypass valve 156 to introduce fresh air directly into the exhaust to dilute the hydrogen being released from the anode, which may reduce pressure within the cathode.

The controls of operation 206 are continued until the anode pressure is determined to be less than a threshold at operation 208. If the anode pressure is less than the threshold at operation 208, the shutdown sequence is complete and the controls 200 are exited.

If the compressor has power, control passes to operation 210 and a different rapid shutdown sequence is executed. Having compressor power facilitates greater precision during the rapid shutdown because airflow through the cathode can be increased or decreased using the compressor in combination with the above-described valves. This allows for better management of the cross pressures within the fuel-cell stack.

At operation 210, the controller discontinues the supply of hydrogen fuel and current draw similar to operation 206. The controller also opens the purge valve until a hydrogen concentration in the exhaust exceeds a threshold, at which point the purge valve is closed, at least until the concentration is below the threshold. The controller may further adjust a speed of the compressor such that a pressure difference between the anode and cathode sides of the fuel cell is reduced. The controller uses the compressor, the exhaust valve, and/or the system bypass valve to maintain the cathode pressure as desired. The controller may also use the compressor, the exhaust valve, and/or the system bypass valve to control the concentration of hydrogen within the exhaust For example, closed-loop feedback controls may be used to control of the compressor speed and the valve positions to maintain the desired cross pressures. For example, the controller can set a constant mass airflow set point and reduce the pressure set point gradually along with a decreasing anode pressure rate thus maintaining the cross pressures within the fuel-cell within the desired envelope. Applicant's U.S. Pat. No. 11,7158,363, which is incorporated by reference herein in its entirety, describes example closed-loop feedback controls for controlling the pressure within the cathode.

The controls of operation 210 continue until the controller determines that the anode pressure is below a threshold in operation 212. Once the anode pressure threshold is reached, control passes to operation 214 and the controller determines if a drying step is required. Drying is used if the ambient temperatures are cold to reduce the accumulation of ice, which may inhibit starting the fuel cell during the next key cycle. If the ambient temperature exceeds the threshold at operation 214, the drying step is skipped.

At operation 218, the fuel-cell is dried by running the compressor to circulate air through the cathode until a desired moisture state is achieved. During the drying, the hydrogen purge valve is closed and the system bypass valve is closed. The humidifier bypass valve 147 is opened to decrease the humidity of the air prior to input 152, The valve 147 may be fully open or it may be at a partial opening to achieve a desired humidity level as measured by the humidity sensor 186. The exhaust throttle valve may be partially opened or fully opened during the drying stage. The duration of the drying stage may be for a predetermined amount of time or may be dynamically controlled. For example, the compressor may run for a predetermined amount of time that is based on readings from the humidity sensor and/or the ambient air temperature sensor. Example dynamic controls include calculating an estimated humidity within the fuel cell and operating the compressor until the estimated humidity is below a desired value. The humidity may be estimated based on the humidity of the incoming air, the mass flow rate of the air, the ambient temperature. In some embodiments, a humidity sensor may be placed downstream of the cathode outlet allowing the cathode humidity to be directly measured.

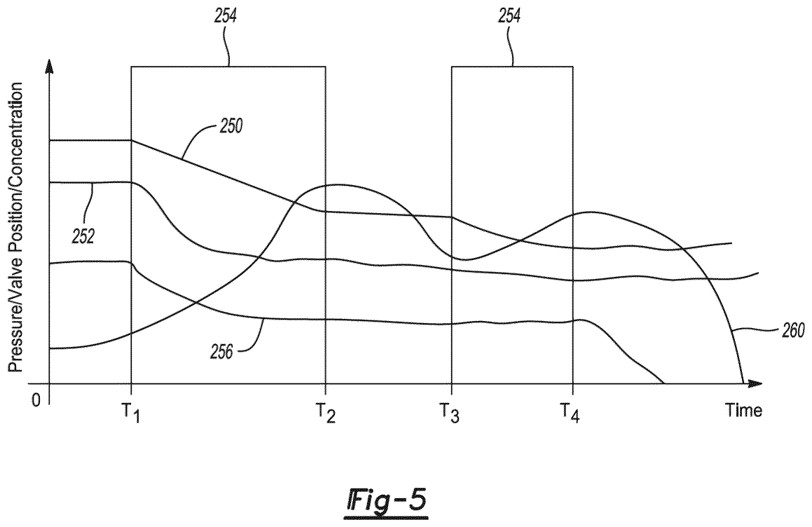

Referring to FIG. 5, a plot of a hypothetical driving situation illustrates the anode side pressure 250, the cathode side pressure 252, the position of the anode purge valve 254, and the position of the cathode exhaust valve 256. (In the plot, valve position is shown as a percentage of open with higher valves indicating the valve is more open.) At tine TI, a rapid shutdown of the fuel-cell is requested. In response, the purge valve position 254 is opened, which releases hydrogen from the anode to the exhaust. The opening of the purge valve 254 resulted in an increase in the cross pressure. To maintain a desired cross pressure between the anode and cathode sides, the position of the cathode exhaust valve 256 is reduced. The opening of the exhaust valve 256 is adjusted between times T1 and T2 to reduce the pressure differential. For example, the valve position of the exhaust valve is adjusted to reduce an error between the anode pressure 250 and cathode pressure 252. As shown, the pressure differential improves by time T2.

At time T2, a hydrogen percentage 260 within the exhaust exceeds the threshold; in response, the purge valve is closed (or alternatively reduced). Closing the purge valve causes the anode pressure 250 to level off. The exhaust valve opening 256 continues to gradual reduce after time T2. At time T3, the hydrogen percentage 260 within exhaust has dropped below the threshold and the purge valve 254 is again opened. At time T4, the shutdown is considered complete, and the purge valve is closed at time T4. The exhaust valve is also closed shortly after time T4.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated.

While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight. manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A fuel-cell system comprising:
a processor programmed to, during shutdown of a fuel-cell stack while a compressor of the fuel-cell system is deactivated, open a purge valve in fluid communication with an anode outlet of the fuel-cell stack, and adjust a position of a cathode exhaust valve based on a pressure difference between an anode side of the fuel-cell stack and a cathode side of the fuel-cell stack.

2. The fuel-cell system of claim 1, wherein the processor is further programmed to, in response to a hydrogen concentration in an exhaust associated with the fuel-cell stack exceeding a threshold, close the purge valve.

3. The fuel-cell system of claim 2, wherein the processor is further programmed to receive a signal from a hydrogen sensor that is indicative of the hydrogen concentration.

4. The fuel-cell system of claim I, wherein the processor is further programmed to, during the shutdown of the fuel-cell stack, open a bypass valve that selectively connects an air-supply system in fluid communication with an exhaust associated with the fuel-cell stack.

5. The fuel-cell system of claim 4, wherein the processor is further programmed to close the bypass valve when a hydrogen concentration in an exhaust associated with the fuel-cell stack is less than a threshold.

6. The fuel-cell system of claim 1, wherein the processor is further programmed to, during a shutdown of the fuel-cell stack with the compressor having power, open the purge valve and reduce compressor speed.

7. The fuel-cell system of claim 1, wherein the processor is further programmed to, during a shutdown of the fuel-cell stack with the compressor having power, open the purge valve until a hydrogen concentration in an exhaust associated with the fuel-cell stack exceeds a threshold.

8. The fuel-cell system of claim 7, wherein the processor is further programmed to receive a signal from a hydrogen sensor that is indicative of the hydrogen concentration.

9. The fuel-cell system of claim 1, wherein the processor is further programmed to, during a shutdown of the fuel-cell stack with the compressor having power, reduce a speed of the compressor such that a pressure difference between the anode and cathode sides of the fuel-cell stack is reduced below a threshold.

10. The fuel-cell system of claim 9 further comprising an anode pressure sensor and a cathode pressure sensor.

11. The fuel-cell system of claim 1, wherein the processor is further programmed to, during a shutdown of the fuel-cell stack with the compressor having power, actuate the compressor and a bypass valve such that a pressure difference between the anode and cathode sides of the fuel-cell stack is reduced.

12. The fuel-cell system of claim 1, wherein the processor is further programmed to, in response to a pressure of the anode side being less than a threshold and an ambient air temperature being less than a threshold, tum the compressor ON.

13. The fuel-cell system of claim 12, wherein the compressor is ON for a predetermined time.

14. A vehicle comprising:
a fuel-cell stack;
an air-supply system including a compressor in fluid communication with a cathode inlet of the fuel-cell stack;
an exhaust in fluid communication with anode and cathode outlets of the fuel-cell stack;
a purge valve in fluid communication with the anode outlet of the fuel-cell stack; and
a processor programmed to, during a shutdown of the fuel-cell stack when the compressor has power, keep the purge valve open until a hydrogen concentration in the exhaust exceeds a threshold, and adjust a speed of the compressor such that a pressure difference between anode and cathode sides of the fuel-cell stack is reduced.

15. The vehicle of claim 14 further comprising a cathode exhaust valve connected in fluid communication between the cathode outlet of the fuel-cell stack and the exhaust, wherein the processor is further programmed to modulate a position of the cathode exhaust valve such that a pressure difference between the anode and cathode sides of the fuel-cell stack is reduced.

16. The vehicle of claim 14 further comprising:
a hydrogen sensor configured to output data indicative of the hydrogen concentration.
an anode pressure sensor; and
a cathode pressure sensor.

17. The vehicle of claim 14 further comprising a bypass valve that selectively connects the air-supply system to the exhaust, wherein the processor is further programmed to, during the shutdown of the fuel-cell stack, open the bypass valve.

18. The vehicle of claim 17, wherein a position of the bypass valve is based on a pressure of the cathode side of the fuel-cell stack and the hydrogen concentration.

19. The vehicle of claim 14, wherein the processor is further programmed to, in response to a pressure of the anode side of the fuel-cell stack being less than a threshold and an ambient air temperature being less than a threshold, turn the compressor ON for a predetermined time to remove moisture from the fuel-cell stack.

20. A method of shutting down a fuel-cell stack comprising:
discontinuing flow of hydrogen to the fuel-cell stack;
maintaining a purge valve, in fluid communication with an anode outlet of the fuel-cell stack, open for as long as a concentration of hydrogen in an exhaust of the fuel-cell stack remains less than a threshold; and
adjusting a position of an exhaust valve to maintain a pressure difference between an anode and a cathode of the fuel-cell stack less than a threshold.
